(19) United States
(12) Patent Application Publication
(10) Pub. No.: US 2011/0201500 A1
(43) Pub. Date: Aug. 18, 2011

(54) Anhydrous Composition Comprising a Dissolved and a Suspended Pesticide, Alkyl Lactate and Alcohol

(75) Inventors: Murat Mertoglu, Ludwigshafen (DE); Winfried Mayer, Bubenheim (DE); Dieter Strobel, Herxheim am Berg (DE); Rainer Berghaus, Speyer (DE); Siegfried Strathmann, Limburgerhof (DE)

(73) Assignee: BASF SE, Ludwigshafen (DE)

(21) Appl. No.: 13/025,647

(22) Filed: Feb. 11, 2011

Related U.S. Application Data
(60) Provisional application No. 61/303,698, filed on Feb. 12, 2010.

(51) Int. Cl. A01N 43/40; A01P 3/00; A01P 13/00; A01P 7/00

(52) U.S. Cl. 504/130; 514/355

(57) ABSTRACT

The present invention relates to an anhydrous formulation comprising a) a first pesticide in dissolved form, b) a second pesticide in the form of suspended particles, c) an alkyl lactate, and d) an alcohol. It further relates to a method of controlling phytopathogenic fungi and/or undesired plant growth and/or undesired insect or mite infestation and/or of regulating the growth of plants, where the specified formulation is allowed to act on the pests in question, their habitat or the plants to be protected from the particular pest, the soil and/or on undesired plants and/or the useful plants and/or their habitat. Furthermore, the invention relates to the use of the formulation for increasing the rain resistance of the applied pesticides.

The present invention relates to an anhydrous formulation comprising a) a first pesticide in dissolved form, b) a second pesticide in the form of suspended particles, c) an alkyl lactate, and d) an alcohol. It further relates to a method of controlling phytopathogenic fungi and/or undesired plant growth and/or undesired insect or mite infestation and/or of regulating the growth of plants, where the specified formulation is allowed to act on the pests in question, their habitat or the plants to be protected from the particular pest, the soil and/or on undesired plants and/or the useful plants and/or their habitat. Furthermore, the invention relates to the use of the formulation for increasing the rain resistance of the applied pesticides. Combinations of preferred features with other preferred features are comprised by the present invention.

Agrochemical formulations should ideally have both a curative effect and also a preventative effect. Some of the known pesticides are particularly curatively effective whereas other pesticides are particularly preventatively effective. Thus, for example, boscalid has good preventative effectiveness when it is applied as suspended particles in a fine distribution over the leaf surface. Epoxiconazole is, for example, particularly curatively effective when it is applied as emulsion. In principle, it is possible to prepare mixtures of such pesticides as tank mixture directly in the spray tank from the separate formulations, for example from a suspension concentrate of boscalid and an emulsion concentrate of epoxiconazole. However, as experience shows, tank mixtures are disadvantageous because different formulations have to be handled and their mixing ratios have to be adjusted. Often, a third pesticide should also additionally be added, for example to a mixture of curative and preventative fungicides, a herbicide, insecticide or growth regulator should also be added. Here, the compatibility of the three formulations is very difficult to predict.

WO 2000/18227 discloses a nonaqueous suspension concentrate comprising 50 to 400 g/l of a crop protection agent, 50 to 700 g/l of an adjuvant and 75 to 500 g/l of a solvent, such as alkyl lactates. Here, the suspension concentrate can comprise a mixture of active ingredients, where one of the active ingredients is dissolved in the continuous phase.

WO 2005/074685 discloses a composition for crop protection comprising 2-ethylhexyl lactate, agrochemical active ingredients dissolved therein and further formulation auxiliaries such as benzyl alcohol.

WO 2007/028538 discloses the use of alkyl lactates for improving the effect of crop protection agents, such as pyraclostrobin or epoxiconazole.

WO 2003/075657 discloses a liquid pesticide composition comprising one or more pesticides as active ingredient and a lactate ester as crystallization inhibitor. Suitable pesticides are, for example, epoxiconazole or pyraclostrobin.

The formulations according to the prior art have various disadvantages: suspension concentrates and emulsion concentrates have hitherto had to be mixed in the tank by the user himself. The formulations were not storage-stable or crystallized out. The rain resistance of the pesticides formulated in this way was low. The pesticides were only absorbed slowly or in small amounts into the leaf of the treated plant. The pesticides exhibit low effectiveness.

It was therefore an object of the present invention to find a formulation comprising at least two pesticides, where both a suspended and also a dissolved active ingredient is combined in a single formulation. The formulation should have high rain resistance. It should be absorbed very readily into the leaf surface. The formulation should also be storage-stable.

The object was achieved by an anhydrous formulation comprising
a) a first pesticide in dissolved form
b) a second pesticide in the form of suspended particles
c) an alkyl lactate, and
d) an alcohol.

Anhydrous formulations comprise in most cases at most 5% by weight of water, preferably at most 1% by weight, particularly preferably at most 0.5% by weight and in particular at most 0.1% by weight.

The first pesticide is present in dissolved form. In most cases, at least 90% by weight of the first pesticide are dissolved, preferably at least 95% by weight and in particular at least 99% by weight. The first pesticide is generally dissolved in a continuous phase of the formulation.

The second pesticide is present in the form of suspended particles. In most cases, at least 90% by weight of the second pesticide are suspended, preferably at least 95% by weight and in particular at least 99% by weight.

The average particle size of the second pesticide can be determined as D₁₀, D₂₀ or D₉₀ (i.e. particle size for which 10%, 20% or 90%, respectively, of the particles are smaller). Preferably, D₁₀ is smaller than 8.0 μm, particularly preferably smaller than 4.0 μm. In a further preferred embodiment, D₂₀ is smaller than 8.0 μm, particularly preferably smaller than 4.0 μm. In a further preferred embodiment, D₉₀ is smaller than 50.0 μm, particularly preferably smaller than 25.0 μm. The average particle size is usually determined in accordance with CIPAC Method MT 187 “PARTICLE SIZE ANALYSIS BY LASER DIFFRACTION”.

Suitable alkyl lactates are C₁-C₁₂ alkyl lactates, where the alkyl radical may be branched or unbranched, saturated or unsaturated. The alkyl radical is preferably branched. The alkyl radical is preferably saturated. The alkyl radical is particularly preferably branched and saturated. Preferred alkyl lactates are C₄-C₈ alkyl lactates, particularly preferably C₆-C₈ alkyl lactates, in particular branched or unbranched octyl lactate. Examples of octyl lactates are 1-ethylhexyl, 2-ethylhexyl, 3-ethylhexyl, 4-ethylhexyl, 1-methylheptyl, 2-methylheptyl, 3-methylheptyl, 4-methylheptyl, 5-methylheptyl, 6-methylheptyl, or n-octyl. A preferred octyl lactate is 2-ethylhexyl lactate. The lactate group can be present in different stereoisomers, for example as D- or L-lactate. Preference is given to the L-lactate group. An especially preferred alkyl lactate is L-(2-ethylhexyl)lactate. The formulation can comprise one or more alkyl lactates, it preferably comprising exactly one alkyl lactate.

The formulation generally comprises 5 to 70% by weight of alkyl lactate, preferably 10 to 60% by weight and in particular 15 to 50% by weight.

Suitable alcohols are all organic solvents with an alcohol group. Usually, the melting point of the alcohol is below 100° C., preferably below 40° C., and in particular below 10° C. As functional groups, the alcohol comprises preferably only at least one alcoholic group, which may, for example, be a primary alcohol group or a phenolic alcohol group. The alcohol preferably comprises an aryl radical, which may comprise up to two heteroatoms, such as phenyl radical or naphthyl radical. Particular preference is given to the alcohol benzyl alcohol or 2-(1-methylpropyl)phenol (also known as “o-sec butylphenol”), in particular benzyl alcohol. The formulation can comprise one or more alcohols, it preferably comprising exactly one alcohol.

The formulation comprises generally 1 to 50% by weight of alcohol, preferably 3 to 30% by weight and in particular 7 to 18% by weight.

The weight ratio of alkyl lactate to alcohol is in most cases in the range from 20/1 to 1/10, preferably from 8/1 to 1/3 and in particular from 5/1 to 1/1. Usually, the alkyl lactate and the alcohol form a homogeneous, continuous phase in the formulation.

The term pesticides refers to at least one active ingredient selected from the group of fungicides, insecticides, nematicides, herbicides, safeners and/or growth regulators. Preferred pesticides are fungicides, insecticides, herbicides, and growth regulators. Particularly preferred pesticides are growth regulators. Mixtures of pesticides of two or more of the aforementioned classes can also be used. The person skilled in the art is familiar with such pesticides, which can be found, for example, in Pesticide Manual, 14th Ed. (2006), The British Crop Protection Council, London. Suitable pesticides are:

A) strobilurins:
azoxystrobin, dimoxystrobin, coumoxystrobin, coumethoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, methyl 2-[2-(2,5-dimethylphenyloxymethyl)phenyl]-3-methoxyacrylate, 2-(2-(3-(2,6-di-chlorophenyl)-1-methylallylideneaminooxymethyl)phenyl)-2-methoxyimino-N-methylacetamide;
   B) carboxamides:
   carboxanilides: benalaxyl, benalaxyl-M, benodanil, bixafen, boscalid, carboxin, fenfuram, fenhexamid, flutolanil, fluxapyroxad, furametpyr, isopyrazam, isotianil, kiralaxyl, mepronil, metalaxyl, metalaxyl-M (mefenoxam), ofurace, oxadixyl, oxycarboxin, penflufen penthiopyrad, sedaxane, tecloftalam, thifluzamide, tiadinil, 2-amino-4-methylthiazole-5-carboxanilide, N-(4′-trifluoromethylthiobiphenyl-2-yl)-3-difluoromethyl-1-methyl-1H-pyrazole-4-carboxamide, N-(2-(1,3,3-trimethylbutyl)-phenyl)-1,3-dimethyl-5-fluoro-1H-pyrazole-4-carboxamide;
   carboxylic acid morpholides: dimethomorph, flumorph, pyrimorph;
   benzamides: flumetover, fluopicolide, fluopyram, zoxamid;
   other carboxamides: carpropamid, diclocymet, mandipropamid, oxytetracyclin, silthiofam, N-(6-methoxypyridin-3-yl)cyclopropanecarboxamide;
      C) azoles:
   triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole;
   imidazoles: cyazofamid, imazalil, imazalil sulfate, pefurazoate, prochloraz, triflumizole;
   benzimidazoles: benomyl, carbendazim, fuberidazole, thiabendazole;
   others: ethaboxam, etridiazole, hymexazole, 2-(4-chlorophenyl)-N-[4-(3,4-dimethoxy-phenyl)isoxazol-5-yl]-2-prop-2-ynyloxyacetamide;
      D) nitrogenous heterocyclyl compounds
   pyridines: fluazinam, pyrifenox, 3-[5-(4-chlorophenyl)-2,3-dimethylisoxazolidin-3-yl]-pyridine, 3-[5-(4-methylphenyl)-2,3-dimethylisoxazolidin-3-yl]pyridine;
   pyrimidines: bupirimate, cyprodinil, diflumetorim, fenarimol, ferimzone, mepanipyrim, nitrapyrin, nuarimol, pyrimethanil;
   piperazines: triforine;
   pyrroles: fludioxonil, fenpiclonil;
   morpholines: aldimorph, dodemorph, dodemorph acetate, fenpropimorph, tridemorph;
   piperidines: fenpropidin;
   dicarboximides: fluorimid, iprodione, procymidone, vinclozolin;
   nonaromatic 5-membered heterocyclic rings: famoxadon, fenamidon, flutianil, octhilinone, probenazole, S-allyl 5-amino-2-isopropyl-3-oxo-4-orthotolyl-2,3-dihydro-pyrazole-1-thiocarboxylate;
   others: acibenzolar-S-methyl, amisulbrom, anilazin, blasticidin-S, captafol, captan, quinomethionate, dazomet, debacarb, diclomezine, difenzoquat, difenzoquat methylsulfate, fenoxanil, folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxypyrimidin-2-yl)-2-methyl-1H-benzimidazole, 5-chloro-7-(4-methylpiperidin-1-yl)-6-(2,4,6-trifluorophenyl)-[1,2,4]triazolo[1,5-a]pyrimidine, 5-ethyl-6-octyl-[1,2,4]triazolo[1,5-a]pyrimidin-7-ylamine;
      E) carbamates and dithiocarbamates
   thio- and dithiocarbamates: ferbam, mancozeb, maneb, metam, methasulphocarb, metiram, propineb, thiram, zineb, ziram;
   carbamates: diethofencarb, benthiavalicarb, iprovalicarb, propamocarb, propamocarb hydrochloride, valiphenal, (4-fluorophenyl)N-(1-(1-(4-cyanophenyl)ethanesulfonyl)-but-2-yl)carbamate;
      F) other fungicides
   guanidines: dodine, dodine free base, guazatine, guazatine acetate, iminoctadine, iminoctadine triacetate, iminoctadine tris(albesilate);
   antibiotics: kasugamycin, kasugamycin hydrochloride hydrate, polyoxins, streptomycin, validamycin A;
   nitrophenyl derivatives: binapacryl, dicloran, dinobuton, dinocap, nitrothal-isopropyl, tecnazene;
   organometallic compounds: fentin salts such as, for example, fentin acetate, fentin chloride, fentin hydroxide;
   sulfurous heterocyclyl compounds: dithianon, isoprothiolane;
   organophosphorus compounds: edifenphos, fosetyl, fosetyl-aluminum, iprobenfos, phosphorous acid and its salts, pyrazophos, tolclofos-methyl;
   organochlorine compounds: chlorthalonil, dichlofluanid, dichlorphen, flusulfamide, hexachlorobenzene, pencycuron, pentachlorophenol and its salts, phthalide, quintozene, thiophanate-methyl, tolylfluanid, N-(4-chloro-2-nitrophenyl)-N-ethyl-4-methylbenzenesulfonamide;
   inorganic active substances: phosphorous acid and its salts, Bordeaux mixture, copper salts such as, for example, copper acetate, copper hydroxide, copper oxychloride, basic copper sulfate, sulfur;
   biological products for controlling fungi, plant strengthening products: Bacillus subtilis strain NRRL No. B-21661 (for example the products RHAPSODY®, SERENADE® MAX and SERENADE® ASO from AgraQuest, Inc., USA.), Bacillus pumilus strain NRRL No. B-30087 (for example SONATA® and BALLAD® Plus from AgraQuest, Inc., USA), Ulocladium oudemansii (for example BOTRY-ZEN from BotriZen Ltd., New Zealand), chitosan (for example ARMOUR-ZEN from BotriZen Ltd., New Zealand).
   others: biphenyl, bronopol, cyflufenamid, cymoxanil, diphenylamine, metrafenon, mildiomycin, oxine-copper, prohexadione-calcium, spiroxamin, tolylfluanid, N-(cyclo-propylmethoxyimino-(6-difluoromethoxy-2,3-difluorophenyl)methyl)-2-phenyl-acetamide, N′-(4-(4-chloro-3-trifluoromethylphenoxy)-2,5-dimethylphenyl)-N-ethyl-N-methylformamidine, N′-(4-(4-fluoro-3-trifluoromethylphenoxy)-2,5-dimethylphenyl)-N-ethyl-N-methylformamidine, N′-(2-methyl-5-trifluoromethyl-4-(3-trimethylsilanyl-propoxy)phenyl)-N-ethyl-N-methylformamidine, N′-(5-difluoromethyl-2-methyl-4-(3-tri-methylsilanylpropoxy)phenyl)-N-ethyl-N-methylformamidine, N-methyl-(1,2,3,4-tetra-hydronaphthalen-1-yl)-2-{1-[2-(5-methyl-3-trifluoromethylpyrazol-1-yl)acetyl]piperidin-4-yl}thiazole-4-carboxylate,
   N-methyl-(R)-1,2,3,4-tetrahydronaphthalen-1-yl2-{1-[2-(5-methyl-3-trifluoromethylpyrazol-1-yl)acetyl]piperidin-4-yl}thiazole-4-carboxylate, 6-tert-butyl-8-fluoro-2,3-dimethylquinolin-4-ylacetate, 6-tert-butyl-8-fluoro-2,3-dimethylquinolin-4-yl methoxyacetate, N-methyl-2-{1-[2-(5-methyl-3-trifluoromethyl-1H-pyrazol-1-yl)acetyl]piperidin-4-yl}-N-[(1R)-1,2,3,4-tetrahydronaphthalen-1-yl]-4-thiazolecarboxamide;
      G) growth regulators
      abscisic acid, amidochior, ancymidole, 6-benzylaminopurine, brassinolide, butralin, chlormequat (chlormequat chloride), choline chloride, cyclanilid, daminozide, dikegulac, dimethipin, 2,6-dimethylpuridine, ethephon, flumetralin, flurprimidol, fluthiacet, forchlorfenuron, gibberellic acid, inabenfid, indole-3-acetic acid, maleic hydrazide, mefluidid, mepiquat (mepiquat chloride), metconazole, naphthaleneacetic acid,
      N-6-benzyladenine, paclobutrazole, prohexadione (prohexadione-calcium), prohydrojasmone, thidiazuron, triapenthenol, tributylphosphorotrithioate, 2,3,5-triiodo-benzoic acid, trinexapac-ethyl and uniconazole;
      H) herbicides
   acetamide: acetochlor, alachlor, butachlor, dimethachlor, dimethenamid, flufenacet, mefenacet, metolachlor, metazachlor, napropamid, naproanilid, pethoxamid, pretilachlor, propachlor, thenylchlor;
   amino acid analogs: bilanafos, glyphosate, glufosinate, sulfosate;
   aryloxyphenoxypropionates: clodinafop, cyhalofop-butyl, fenoxaprop, fluazifop, haloxyfop, metamifop, propaquizafop, quizalofop, quizalofop-P-tefuryl;
   bipyridyls: diquat, paraquat;
   carbamates and thiocarbamates: asulam, butylate, carbetamide, desmedipham, dimepiperat, eptam (EPTC), esprocarb, molinate, orbencarb, phenmedipham, prosulfocarb, pyributicarb, thiobencarb, triallate;
   cyclohexanediones: butroxydim, clethodim, cycloxydim, profoxydim, sethoxydim, tepraloxydim, tralkoxydim;
   dinitroanilines: benfluralin, ethaifluralin, oryzalin, pendimethalin, prodiamine, trifluralin;
   diphenyl ethers: acifluorfen, aclonifen, bifenox, diclofop, ethoxyfen, fomesafen, lactofen, oyfluorfen;
   hydroxybenzonitriles: bromoxynil, dichiobenil, ioxynil;
   imidazolinones: imazamethabenz, imazamox, imazapic, imazapyr, imazaquin, imazethapyr;
   phenoxyacetic acids: clomeprop, 2,4-dichlorophenoxyacetic acid (2,4-D), 2,4-DB, dichiorprop, MCPA, MCPA-thioethyl, MCPB, mecoprop;
   pyrazines: chloridazon, flufenpyr-ethyl, fluthiacet, norflurazon, pyridate;
   pyridines: aminopyralid, clopyralid, diflufenican, dithiopyr, fluridone, fluoroxypyr, picloram, picolinafen, thiazopyr;
   sulfonylureas: amidosulfuron, azimsulfuron, bensulfuron, chiorimuron-ethyl, chlorsulfuron, cinosulfuron, cyclosulfamuron, ethoxysulfuron, flazasulfuron, fluceto-sulfuron, flupyrsulfuron, foramsulfuron, halosulfuron, imazosulfuron, iodosulfuron, mesosulfuron, metsulfuron-methyl, nicosulfuron, oxasulfuron, primisulfuron, pro-sulfuron, pyrazosulfuron, rimsulfuron, sulfometuron, sulfosulfuron, thifensulfuron, tria-sulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxypyrimidin-2-yl)urea;
   triazines: ametryne, atrazine, cyanazine, dimethametryne, ethiozine, hexazinone, metamitron, metribuzine, prometryne, simazine, terbuthylazine, terbutryne, triaziflam;
   ureas: chlortoluron, daimuron, diuron, fluometuron, isoproturon, linuron, methabenz-thiazuron, tebuthiuron;
   other acetolactate synthase inhibitors: bispyribac-sodium, cloransulam-methyl, diclosulam, florasulam, flucarbazone, flumetsulam, metosulam, orthosulfamuron, penoxsulam, propoxycarbazone, pyribambenz-propyl, pyribenzoxim, pyriftalide, pyriminobac-methyl, pyrimisulfan, pyrithiobac, pyroxasulfon, pyroxsulam;
   others: amicarbazone, aminotriazole, anilofos, beflubutamid, benazolin, bencarbazone, benfluresate, benzofenap, bentazone, benzobicyclon, bromacil, bromobutide, butafenacil, butamifos, cafenstrole, carfentrazone, cinidon-ethlyl, chiorthal, cinmethylin, clomazone, cumyluron, cyprosulfamid, dicamba, difenzoquat, diflufenzopyr, Drechslera monoceras, endothal, ethofumesate, etobenzanid, fentrazamide, flumiclorac-pentyl, flumioxazin, flupoxam, fluorochloridon, flurtamon, indanofan, isoxaben, isoxaflutol, lenacil, propanil, propyzamide, quinclorac, quinmerac, mesotrione, methylarsenic acid, naptalam, oxadiargyl, oxadiazone, oxaziclomefon, pentoxazone, pinoxaden, pyraclonil, pyraflufen-ethyl, pyrasulfotol, pyrazoxyfen, pyrazolynate, quinoclamin, saflufenacil, sulcotrione, sulfentrazone, terbacil, tefuryltrione, tembotrione, thiencarbazone, topramezone, 4-hydroxy-3-[2-(2-methoxyethoxymethyl)-6-trifluoromethylpyridin-3-carbonyl]bicyclo[3.2.1]oct-3-en-2-one,
   ethyl (3-[2-chloro-4-fluoro-5-(3-methyl-2,6-dioxo-4-trifluoromethyl-3,6-dihydro-2H-pyrimidin-1-yl)phenoxy]pyridin-2-yloxy)acetate, methyl 6-amino-5-chloro-2-cyclo-propylpyrimidine-4-carboxylate, 6-chloro-3-(2-cyclopropyl-6-methylphenoxy)-pyridazin-4-ol, 4-amino-3-chloro-6-(4-chlorophenyl)-5-fluoropyridin-2-carboxylic acid, methyl 4-amino-3-chloro-6-(4-chloro-2-fluoro-3-methoxyphenyl)pyridin-2-carboxylate and methyl 4-amino-3-chloro-6-(4-chloro-3-dimethylamino-2-fluorophenyl)pyridin-2-carboxylate;
      I) insecticides
   organo(thio)phosphates: acephate, azamethiphos, azinphos-methyl, chlorpyrifos, chlorpyrifos-methyl, chlorfenvinphos, diazinon, dichlorvos, dicrotophos, dimethoat, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
   carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
   pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalo-thrin, permethrin, prallethrin, pyrethrin I and II, resmethrin, silafluofen, tau-fluvalinate, tefluthrin, tetramethrin, tralomethrin, transfluthrin, profluthrin, dimefluthrin,
   insect growth inhibitors: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazin; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramate;
   nicotine receptor agonists/antagonists: clothianidin, dinotefuran, imidacloprid, thiamethoxam, nitenpyram, acetamiprid, thiacloprid, 1-(2-chlorothiazol-5-ylmethyl)-2-nitrimino-3,5-dimethyl-[1,3,5]triazinane;
   GABA antagonists: endosulfan, ethiprole, fipronil, vaniliprole, pyrafluprole, pyriprole, N-5-amino-1-(2,6-dichloro-4-methylphenyl)-4-sulfinamoyl-1H-pyrazole-3-thiocarbox-amide;
   macrocyclic lactones: abamectin, emamectin, milbemectin, lepimectin, spinosad, spinetoram;
   mitochondrial electron transport chain inhibitor (METI) I acaricides: fenazaquin, pyridaben, tebufenpyrad, tolfenpyrad, flufenerim;
   METI II and III substances: acequinocyl, fluacyprim, hydramethylnone;
   decouplers: chlorfenapyr;
   inhibitors of oxidative phosphorylation: cyhexatin, diafenthiuron, fenbutatin oxide, propargite;
   insect ecdysis inhibitors: cryomazin;
   ‘mixed function oxidase’ inhibitors: piperonyl butoxide;
   sodium channel blockers: indoxacarb, metaflumizon;
   others: benclothiaz, bifenazate, cartap, flonicamid, pyridalyl, pymetrozin, sulfur, thiocyclam, flubendiamid, chlorantraniliprole, cyazypyr (HGW86); cyenopyrafen, flupyrazofos, cyflumetofen, amidoflumet, imicyafos, bistrifluoron and pyrifluquinazone.

The first pesticide is preferably a pesticide which is soluble to at least 95% by weight in a mixture of 2-ethylhexyl lactate and benzyl alcohol (weight ratio 3:1) at 20° C. The first pesticide is particularly preferably epoxiconazole, pyraclostrobin, or metconazole, specifically epoxiconazole or pyraclostrobin.

Besides the first pesticide, further pesticides may also be present in dissolved form. Preferred further pesticides which are present in dissolved form are epoxiconazole or pyraclostrobin.

The formulation comprises generally 0.01 to 50% by weight of the first pesticide, preferably 0.5 to 25% by weight and in particular 3 to 15% by weight.

The second pesticide is preferably a pesticide which is soluble to at most 5% by weight in a mixture of 2-ethylhexyl lactate and benzyl alcohol (weight ratio 3:1) at 20° C. The second pesticide is particularly preferably boscalid, chlorothalonil, or fluxapyroxad, especially boscalid.

Besides the second pesticide, further pesticides may also be present in the form of suspended particles.

The formulation comprises generally 0.01 to 50% by weight of the second pesticide, preferably 1 to 30% by weight and in particular 8 to 20% by weight.

The weight ratio of the first to second pesticide is in most cases in the range from 50/1 to 1/50, preferably from 5/1 to 1/10 and in particular from 2/1 to 1/4.

Furthermore, the formulations according to the invention may also comprise customary auxiliaries for agrochemical formulations, the choice of auxiliaries depending on the specific application form and/or the active ingredient. Examples of suitable auxiliaries are further solvents, solid carriers, surface-active substances (such as surfactants, solubilizers, protective colloids, wetting agent and tackifiers), organic and inorganic thickeners, bactericides, antifreezes, antifoams, optionally dyes and adhesives (e.g. for the treatment of seed material) or customary auxiliaries for bait formulation (e.g. attractants, feedants, bittering substances).

Besides the alcohol and the alkyl lactate, suitable further solvents are organic solvents such as mineral oil fractions of medium to high boiling point, such as kerosene and diesel oil, and also coal tar oils, and oils of vegetable or animal origin, aliphatic, cyclic and aromatic hydrocarbons, e.g. paraffins, tetrahydronaphthalene, alkylated naphthalenes and derivatives thereof, alkylated benzenes and derivatives thereof, alcohols such as methanol, ethanol, propanol, butanol and cyclohexanol, glycols, ketones such as cyclohexanone, gamma-butyrolactone, dimethyl fatty acid amides, fatty acids and fatty acid esters and strongly polar solvents, e.g. amines such as N-methylpyrrolidone. In principle, it is also possible to use solvent mixtures, and also mixtures of the aforementioned solvents and water. Preferably, besides the alcohol and the alkyl lactate, the formulation comprises at most 20% by weight, preferably at most 5% by weight and in particular at most 1% by weight, of further solvents.

Solid carriers are mineral earths such as silicas, silica gels, silicates, talc, kaolin, limestone, lime, chalk, bole, loess, clay, dolomite, diatomaceous earth, calcium sulfate and magnesium sulfate, magnesium oxide, ground plastics, fertilizers, such as ammonium sulfate, ammonium phosphate, ammonium nitrate, ureas and vegetable products such as cereal meal, tree bark meal, wood meal and nutshell meal, cellulose powders or other solid carriers. The formulation preferably comprises no solid carriers.

Suitable surface-active substances (adjuvants, wetting agents, tackifiers, dispersants or emulsifiers) are the alkali metal salts, alkaline earth metal salts, ammonium salts of aromatic sulfonic acids, e.g. of lignosulfonic acid (Borresperse® grades, Borregaard, Norway), phenolsulfonic acid, naphthalenesulfonic acid (Morwet® grades, Akzo Nobel, USA) and dibutylnaphthalenesulfonic acid (Nekal® grades, BASF, Germany), and also of fatty acids, alkyl- and alkylarylsulfonates, alkyl ether, lauryl ether and fatty alcohol sulfates, and also salts of sulfated hexa-, hepta- and octadecanoles, and also of fatty alcohol glycol ethers, condensation products of sulfonated naphthalene and its derivatives with formaldehyde, condensation products of naphthalene or of naphthalenesulfonic acids with phenol and formaldehyde, polyoxyethylene octylphenol ether, ethoxylated isooctyl-, octyl- or nonylphenol, alkylphenyl polyglycol ethers, tributylphenyl polyglycol ethers, alkylaryl polyether alcohols, isotridecyl alcohol, fatty alcohol ethylene oxide condensates, ethoxylated castor oil, polyoxyethylene or polyoxypropylene alkyl ethers, lauryl alcohol polyglycol ether acetate, sorbitol esters, lignosulfite liquors, and also proteins, denatured proteins, polysaccharides (e.g. methylcellulose), hydrophobically modified starches, polyvinyl alcohol (Mowiol® grades, Clariant, Switzerland), polycarboxylates (Sokalan® grades, BASF, Germany), polyalkoxylates, polyvinylamine (Lupamin® grades, BASF, Germany), polyethylenimine (Lupasol® grades, BASF, Germany), polyvinylpyrrolidone and copolymers thereof.

Suitable surfactants are in particular anionic, cationic, nonionic and amphoteric surfactants, block polymers and polyelectrolytes. Suitable anionic surfactants are alkali metal salts, alkaline earth metal salts or ammonium salts of sulfonates, sulfates, phosphates or carboxylates. Examples of sulfonates are alkylarylsulfonates, diphenylsulfonates, alpha-olefinsulfonates, lignosulfonates, sulfonates of fatty acids and oils, sulfonates of ethoxylated alkylphenols, sulfonates of condensed naphthalenes, sulfonates of dodecyl and tridecylbenzenes, sulfonates of naphthalenes and alkylnaphthalenes, sulfosuccinates or sulfosuccinamates. Examples of sulfates are sulfates of fatty acid and oils, of ethoxylated alkylphenols, of alcohols, of ethoxylated alcohols, or of fatty acid esters. Examples of phosphates are phosphate esters. Examples of carboxylates are alkyl carboxylates and carboxylated alcohol or alkylphenol ethoxylates.

Suitable nonionic surfactants are alkoxylates, N-alkylated fatty acid amides, amine oxides, esters or sugar-based surfactants. Examples of alkoxylates are compounds such as alcohols, alkylphenols, amines, amides, arylphenols, fatty acids or fatty acid esters which have been alkoxylated. For the alkoxylation, ethylene oxide and/or propylene oxide can be used, preferably ethylene oxide. Examples of N-alkylated fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkyl polyglucosides.

Suitable cationic surfactants are quaternary surfactants, for example quaternary ammonium compounds with one or two hydrophobic groups, or salts of long-chain primary amines. The formulation according to the invention comprises preferably up to 5.0% by weight of cationic surfactants, particularly preferably up to 0.5% by weight, and specifically up to 0.05% by weight.

Suitable amphoteric surfactants are alkylbetaines and imidazolines. Suitable block polymers are block polymers of the A-B or A-B-A type comprising blocks of polyethylene oxide and polypropylene oxide or of the A-B-C type comprising alkanol, polyethylene oxide and polypropylene oxide. Suitable polyelectrolytes are polyacids or polybases. Examples of polyacids are alkali metal salts of polyacrylic acid. Examples of polybases are polyvinylamines or polyethyleneamines.

The formulation according to the invention can comprise 0.1 to 40% by weight, preferably 1 to 30% by weight and in particular 2 to 20% by weight, total amount of surface-active substances and surfactants, based on the total amount of the formulation.

Suitable thickeners are compounds which impart a modified flow behavior to the formulation, i.e. a high viscosity in the resting state and low viscosity in the agitated state. Examples are polysaccharides, proteins (such as casein or gelatin), synthetic polymers, or inorganic layered minerals. Such thickeners are commercially available, for example xanthan gum (Kelzan®, CP Kelco, USA), Rhodopol® 23 (Rhodia, France) or Veegum® (R. T. Vanderbilt, USA) or Attaclay® (Engelhard Corp., NJ, USA). Preferred thickeners are inorganic layered minerals and polysaccharides, in particular inorganic layered minerals.

The content of thickener in the formulation depends on the effectiveness of the thickener. The person skilled in the art will choose a content in order to obtain the desired viscosity of the formulation. The content will in most cases be 0.01 to 10% by weight.

Bactericides may be added for stabilizing the composition. Examples of bactericides are those based on dichlorophen and benzyl alcohol hemiformal, and also isothiazolinone derivatives such as alkylisothiazolinones and benzoisothiazolinones (Acticide® MBS from Thor Chemie). Examples of suitable antifreezes are ethylene glycol, propylene glycol, urea and glycerol. Examples of antifoams are silicone emulsions (such as e.g. Silikon® SRE, Wacker, Germany or Rhodorsil®, Rhodia, France), long-chain alcohols, fatty acids, salts of fatty acids, organofluorine compounds and mixtures thereof.

The user customarily uses the formulation according to the invention for application in a premetering device, in a rucksack sprayer, in a spray tank or in a spraying aircraft. Here, the formulation is brought to the desired use concentration with water and/or buffer, optionally with the addition of further auxiliaries, and thus giving the ready-to-use spray mixture (so-called tank mix). Usually, 50 to 500 liters of the ready-to-use spray mixture are applied per hectare of utilizable agricultural area, preferably 100 to 400 liters. The active ingredient concentrations in the ready-to-use preparations may be varied within relatively large ranges. In general, they are between 0.0001 and 10%, preferably between 0.01 and 1%.

Oils of various types, wetting agents, adjuvants, herbicides, bactericides, other fungicides and/or pesticides can be added to the active ingredients or to the compositions comprising these, and optionally to the tank mix, immediately prior to use. These agents can be admixed to the compositions according to the invention in the weight ratio 1:100 to 100:1, preferably 1:10 to 10:1. Suitable adjuvants within this context are in particular: organically modified polysiloxanes, e.g. Break Thru S 240®; alcohol alkoxylates, e.g. Atplus® 245, Atplus® MBA 1303, Plurafac® LF 300 and Lutensol® ON 30; EO-PO block polymers, e.g. Pluronic® RPE 2035 and Genapol® B; alcohol ethoxylates, e.g. Lutensol® XP 80; and sodium dioctyl sulfosuccinate, e.g. Leophen® RA.

Depending on the nature of the desired effect, the application rates when used in crop protection are between 0.001 and 2.0 kg of active ingredient per ha, preferably between 0.005 and 2 kg per ha, particularly preferably between 0.05 and 0.9 kg per ha, in particular between 0.1 and 0.75 kg per ha.

The present invention further relates to a method of controlling phytopathogenic fungi and/or undesired plant growth and/or undesired insect or mite infestation and/or of regulating the growth of plants, where the formulation according to the invention is allowed to act on the pests in question, their habitat or the plants to be protected from the particular pest, the soil and/or on undesired plants and/or the useful plants and/or their habitat.

The present invention further relates to the use of the formulation according to the invention for increasing the rain resistance of the applied pesticides.

The present invention further relates to the use of the formulation according to the invention for increasing the absorption of the applied pesticides into the plant.

Advantages of the invention are that suspended active ingredients and dissolved active ingredients can now be combined in one formulation meaning that, for example, it is possible to dispense with laborious tank mixing of the individual formulation. The formulation is storage-stable (even upon repeated cooling below 0° C.) and does not crystallize out. The pesticides have a high rain resistance. The pesticides are absorbed very rapidly and in large amounts into the leaf of the treated plant. The pesticides exhibit higher effectiveness compared to conventionally formulated active ingredients. The yield of the treated plants increases.

The examples below illustrate the invention without limiting it.

### EXAMPLES

Nonionic surfactant A: alkoxylated fatty alcohol, liquid at 25° C.; surface tension for 1 g/l in water at 23° C. (DIN 53 914) 28 to 31 mN/m; cloud point according to EN 1890 Method A 21-22° C.; setting point according to DIN 51583 —10° C.
Nonionic surfactant B: polyaromatic ethoxylate, setting point 14° C.; surface tension for 0.1% in water at 25° C. (DIN 53 914) 40 to 41 mN/m.
Nonionic surfactant C: organomodified siloxane, liquid, pH neutral in water, setting point—10° C.
Nonionic surfactant D: ethoxylate propoxylate of a short-chain fatty alcohol, melting point 30° C., surface tension for 0.1% in water at 25° C. (DIN 53 914) 31-32 mN/m
Nonionic surfactant E: tristyrylphenol ethoxylate.
Nonionic surfactant F: castor oil, ethoxylated; liquid, water solubility 200 g/l; surface tension 44-45 mN/m (OECD ring method).
Anionic surfactant A: polyetherphosphate, pH in water (100 g/l) at 23° C. 2.0.
Anionic surfactant B: alkylbenzenesulfonate 60% by weight dissolved in branched alcohol, setting point −31° C.
Thickener A: organically modified hectorite, finely divided powder.
Thickener B: sheet silicate based on an organically modified smectite, finely divided powder.

### Example 1

### Epoxiconazole & Boscalid in EHL & Benzyl Alcohol

Epoxiconazole was stirred in a mixture of 200 g of 2-ethylhexyl(S)-lactate (EHL) and 125 g of benzyl alcohol until the active ingredient had dissolved. Then, the other formulation auxiliaries were added (see Table 1) and the mixture was stirred for 10 min. Finally, boscalid was added, and the mixture was stirred for 5 min and topped up to 1.0 l with 2-ethylhexyl lactate. The resulting suspension was ground using a ball mill. The particle size was below 4 μm (50%) or below 25 μm (90%).

Stability test: the formulation was subjected to a temperature cycle from −10° C. to +10° C. for one week. The formulation was stable and no deposition of the suspended particles was found. The viscosity of the formulation was likewise uniformly stable. No crystal growth was found either.

### Example 2

### Epoxiconazole & Pyraclostrobin & Boscalid in EHL & Benzyl Alcohol

Epoxiconazole and pyraclostrobin were stirred in a mixture of 200 g of 2-ethylhexyl lactate and 125 g of benzyl alcohol until the two active ingredients had dissolved. The other formulation auxiliaries were then added (see Table 1) and the mixture was stirred for 10 min. Finally, boscalid was added, and the mixture was stirred for 5 min and topped up to 1.0 l with 2-ethylhexyl lactate. The resulting suspension was ground using a ball mill. The particle size was below 4 μm (50%) or below 25 μm (90%).

The stability test (see Example 1) again exhibited a stable formulation: the formulation was stable and no deposition of the suspended particles was found. The viscosity of the formulation was likewise uniformly stable. No crystal growth was found either.

### Example 3

### Epoxiconazole & Boscalid in Benzyl Alcohol (not According to the Invention)

Epoxiconazole was stirred in a mixture of 300 g of benzyl alcohol until the active ingredient had dissolved. The other formulation auxiliaries were then added (see Table 1) and the mixture was stirred for 10 min. Finally, boscalid was added, and the mixture was stirred for 5 min and topped up to 1.0 l with benzyl alcohol. The resulting suspension was ground using a ball mill. The particle size was below 4 μm (50%) or below 25 μm (90%).

In the stability test (see Example 1), large crystals of boscalid were formed and irreversible phase separation was observed.

### Example 4

### Epoxiconazole & Boscalid in EHL (not According to the Invention)

Epoxiconazole was stirred in a mixture of 300 g of 2-ethylhexyl lactate, the active ingredient becoming suspended. The other formulation auxiliaries were then added (see Table 1) and the mixture was stirred for 10 min. Finally, boscalid was added, and the mixture was stirred for 5 min and topped up to 1.0 l with 2-ethylhexyl lactate. The resulting suspension was ground using a ball mill. The particle size was below 4 μm (50%) or below 25 μm (90%).

In the stability test (see Example 1), epoxiconazole was only partially soluble. Irreversible phase separation was observed.

### Example 5

### Epoxiconazole & Boscalid in EHL & Benzyl Alcohol & Water (not According to the Invention)

Epoxiconazole was stirred in a mixture of 200 g of 2-ethylhexyl lactate and 125 g of benzyl alcohol until the active ingredient had dissolved. The further formulation auxiliaries were then added (see Table 1), and the mixture was stirred for 10 min and then topped up to 1.0 l with 2-ethylhexyl lactate (mixture A).

An aqueous suspension concentrate (280 ml) comprising 500 g/l of boscalid and 1.7% by weight of phenolsulfonic acid-formaldehyde polycondensate sodium salt was topped up to 1.5 l with water. With slow stirring, mixture A was added and, finally, the mixture was topped up to 3.0 l with water. This gave an aqueous suspoemulsion.

In the stability test (see Example 1), crystals of epoxiconazole were formed. The suspoemulsion was not stable.

TABLE 1
Composition of Examples 1 to 5 (all concentrations in g/l)

| Example No. | 1 | 2 | 3 ^{a)} | 4 ^{a)} | 5 ^{a)} | 6 ^{a)} |
|---|---|---|---|---|---|---|
| Boscalid | 140 | 140 | 140 | 140 | 140 | — |
| Epoxiconazole | 50 | 50 | 50 | 50 | 50 | — |
| Pyraclostrobin | — | 60 | — | — | — | 60 |
| Nonionic surfactant A | 100 | 100 | 100 | 100 | 100 | 100 |
| Nonionic surfactant B | 18 | 18 | 18 | 18 | 18 | 18 |
| Thickener A | 8 | — | 8 | 8 | — | — |
| Thickener B | — | 15 | — | — | — | 15 |
| Anionic surfactant A | 40 | 40 | 40 | 40 | 40 | 40 |
| Nonionic surfactant C | — | 100 | — | — | — | 100 |
| Nonionic surfactant D | 18 | 18 | 18 | 18 | 18 | 18 |
| Propylene carbonate | 2.4 | — | 2.4 | 2.4 | — | — |
| Nonionic surfactant E | 60 | 60 | 60 | 60 | 60 | 60 |
| Nonionic surfactant F | — | 50 | — | — | — | 50 |
| Anionic surfactant B | 24 | 24 | 24 | 24 | 24 | 24 |
| Benzyl alcohol | 125 | 125 | ad 1 l | — | 125 | 125 |
| 2-Ethylhexyl (S)-lactate | ad 1 l | ad 1 l | — | ad 1 l | ad 1 l | ad 1 l |
| Water | — | — | — | — | ad 3 l | — |

^{a)} not according to the invention

### Example 6

### Rain Resistance

Wheat plants (15 plants per pot, in each case 4 pots) were sprayed with the formulations from Example 1 or 2, in each case with an application rate of 2.5 l/ha. For comparison, one experimental series was not sprayed. One hour after spraying, rain was simulated in an amount of 30 mm. For comparison, in each case one experimental series was not subjected to rain. After 36 days, infestation with Septoria was graded. The results are summarized in Table 2. As comparison (not according to the invention), Bell® from BASF SE was used (an aqueous suspension concentrate of 233 g/l (20.8% by weight) of boscalid and 67 g/l (6% by weight) of epoxiconazole, 11.2-12.6% by weight fatty alcohol alkoxylate), using the same application rate. The experiment showed that the rain resistance of the formulations according to the invention is very good.

TABLE 2
Rain resistance (% infestation with Septoria)

| | Without rain | With rain | With rain |
|---|---|---|---|
| Formulation | [% infestation] | [% infestation] | [% infestation] |
| Without treatment | 78 | 85 | 75 |
| Example 1 | 0 | 0 | 0 |
| Example 2 | 0 | 0 | 0 |
| Bell ®^{a)} | 0 | 7 | 6 |

^{a)}not according to the invention

### Example 7

### Spreading the Spray Drop on the Leaf Surface

To determine the spreading behavior of spray drops, spray mixtures were prepared in the customary field concentration in CIPAC water D. In each case, 1 μl drops were placed onto the leaf surface using a Hamilton syringe and the spreading of the spray drop during drying was visually monitored with the help of a stereomicroscope. The size of the drop immediately after placement (F₀) and the size of the drop after drying (F_{E}) were measured. The experiments were repeated several times and the averages were calculated. Evaluation was carried out in accordance with the following formula: spreading factor (in percent)=F_{E}:F₀×100%.

The experiment showed the higher spreading formulation on leaf surfaces.

TABLE 3
Spreading

| Spray mixture | |
|---|---|
| comprising formulation of | Spreading factor |
| Example 1 | >1000% |
| Example 2 | >1000% |
| Bell ®^{a)} | ~600% |

^{a)}not according to the invention

### Example 8

### Active Ingredient Absorption

To determine the active ingredient absorption, wheat plants (melon, winter wheat) were grown in a greenhouse to stage 36 BBCH. The corresponding formulations (see Table 4, 5) were applied in a laboratory spray track with the following parameters:

product application rate: corresponding to the field concentration
water application rate: 200 l/ha
nozzle type: Lechler ID 120 02 (air injector flat-spray nozzle)
pressure: 3.33 bar
traveling speed: 5 km/h

Following application, the wheat plants were further cultivated again for 7 days in the greenhouse. The treated leaves were then cut off and weighed. In a first step, 30-40 g of leaves were cut up small into pieces measuring ca. 5 cm and washed with 200 ml of methanol (50%). A further washing step then took place with 100 ml of methanol (50%). The washing media were separated from the leaves, combined, and analyzed by means of LC-MS-MS (Table 4, 5 “Washable”).

The leaves were then treated with 400 ml of extraction medium (70% methanol, 25% water, 5% 2N HCl) and comminuted using a dispersing rod. One aliquot (ca. 10 ml) of the supernatant was transferred to a centrifuge tube and centrifuged for 5 min at 3000 rpm. 2 ml of the supernatant were placed in a test tube which comprised 2 ml of 0.2N NaOH. 5 ml of cyclohexane were added and the mixture is shaken for 20 min. 1 ml aliquot of the cyclohexane phase was pipetted into a chromatography vial and evaporated to dryness by means of nitrogen. The residue was taken up in 1 ml of methanol (50%), diluted and analyzed like the washing solution by means of LC-MS-MS (Table 4, 5 “Absorption”).

The recovery rate of the various active ingredients was determined with untreated plants and active ingredient additions of 1 and 5 mg/kg of leaf mass. For comparison, the commercially available formulations Bell® and Diamant® (suspoemulsion, 114 g/l of pyraclostrobin, 43 g/l of epoxiconazole, 214 g/l fenpropimorph, 17% by weight of solvent naphtha, 11% by weight of fatty alcohol alkoxylate, 5% by weight of phenolsulfonic acid-formaldehyde polycondensate sodium salt) from BASF SE were used, and also an aqueous suspension concentrate containing 160 g/l of epoxiconazole, 260 g/l of pyraclostrobin (“Comparison A”).

The experiments showed that the active ingredients formulated according to the invention are better absorbed into the plants than known formulations of these active ingredients.

TABLE 4
Active ingredient absorption

| | Bell ®^{a)} | | Example 1 | |
|---|---|---|---|---|
| | Washable | Absorption | Washable | Absorption |
| Epoxiconazole | 75 | 25 | 29 | 71 |
| Boscalid | 94 | 6 | 92 | 8 |

^{a)}not according to the invention

TABLE 5
Active ingredient absorption

| | Comparison A ^{a)} | | Bell ® + Diamant ® ^{a), b)} | | Example 2 | |
|---|---|---|---|---|---|---|
| | Washable | Absorption | Washable | Absorption | Washable | Absorption |
| Epoxiconazole | 90 | 10 | 63 | 37 | 21 | 79 |
| Boscalid | — | — | 91 | 9 | 90 | 10 |
| Pyraclostrobin | 92 | 8 | 66 | 34 | 52 | 48 |

^{a)} not according to the invention;
^{b)} weight ratio 1/1.

### Example 9

### Biological Effectiveness

The biological effectiveness against Septoria tritici was tested on wheat plants in field experiments upon use to BBCH 31-59. 21-42 days after application, the infestation of Septoria was graded and the efficacy was calculated. Whereas in the case of plants treated with Bell®, an average efficacy (n=4) of 72% was found, the formulation from Example 1 exhibited an average effectiveness of 90%.

### Example 10

### Yield Increase

The yield of wheat was measured in field experiments in Europe. The untreated fields had on average (n=13) a yield of 85.1 dt/ha, the fields treated with Bell® 97.8 dt/ha and the fields treated with the formulation from Example 1101.6 dt/ha.

### Example 11

### Biological Effectiveness

The biological effectiveness against net blotch was tested on barley plants upon use to BBCH 31-62. 21-42 days after application, the infestation was graded and the efficacy calculated. Whereas in the case of the plants treated with Bell® an average effectiveness (n=8) of 71% was found, the formulation from Example 1 exhibited an average effectiveness of 84%.

### Example 12

### Biological Effectiveness

The biological effectiveness against brown rust was tested on winter wheat upon use to BBCH 32-59. 30-50 days after application, the infestation was graded and the efficacy calculated. Whereas in the case of the plants treated with Bell® an average effectiveness (n=6) of 83% was found, the formulation from Example 1 exhibited an average effectiveness of 88%, and the formulation from Example 2 an average effectiveness of 95%.

### Example 13

### Biological Effectiveness

The biological effectiveness against Rhynchosporium was tested on barley upon use to BBCH 31-49. 20-50 days after application, the infestation was graded and the efficacy calculated. Whereas in the case of the plants treated with Bell® an average effectiveness (n=4) of 55% was found, the formulation from Example 1 exhibited an average effectiveness of 65%, and the formulation from Example 2 an average effectiveness of 77%.

1-12. (canceled)

13. An anhydrous formulation comprising:
a) a first pesticide in dissolved form,
b) a second pesticide in the form of suspended particles,
c) an alkyl lactate, and
d) an alcohol.

14. The formulation of claim 13, wherein the alkyl lactate is 2-ethylhexyl lactate.

15. The formulation of claim 13, wherein the alcohol is benzyl alcohol or 2-(1-methylpropyl)phenol.

16. The formulation of claim 13, wherein the first pesticide is soluble to at least 95% by weight in a mixture of 2-ethylhexyl lactate and benzyl alcohol (weight ratio 3:1) at 20° C.

17. The formulation of claim 13, wherein the second pesticide is soluble to at most 5% by weight in a mixture of 2-ethylhexyl lactate and benzyl alcohol (weight ratio 3:1) at 20° C.

18. The formulation of claim 13, wherein the first pesticide is selected from the group consisting of epoxiconazole, pyraclostrobin, or metconazole.

19. The formulation of claim 13, wherein the second pesticide is selected from the group consisting of boscalid, chlorothalonil, or fluxapyroxad.

20. The formulation of claim 13, further comprising a thickener.

21. The formulation of claim 13, wherein the average particle size D₉₀ of the second pesticide is less than 50 μm.

22. A method of controlling phytopathogenic fungi and/or undesired plant growth and/or undesired insect or mite infestation and/or of regulating the growth of plants, wherein the formulation of claim 13 is allowed to act on the pests in question, their habitat or the plants to be protected from the particular pest, the soil and/or on undesired plants and/or the useful plants and/or their habitat.

23. A method of increasing rain resistance of applied pesticides comprising formulating the pesticides according to the formulation of claim 13.

24. A method of for increasing the absorption of the applied pesticides into the plant comprising formulating the pesticides according to the formulation of claim 13.

25. The method of claim 22, wherein the alkyl lactate is 2-ethylhexyl lactate.

26. The method of claim 22, wherein the alcohol is benzyl alcohol or 2-(1-methylpropyl)phenol.

27. The method of claim 22, wherein the first pesticide is soluble to at least 95% by weight in a mixture of 2-ethylhexyl lactate and benzyl alcohol (weight ratio 3:1) at 20° C.

28. The method of claim 22, wherein the second pesticide is soluble to at most 5% by weight in a mixture of 2-ethylhexyl lactate and benzyl alcohol (weight ratio 3:1) at 20° C.

29. The method of claim 22, wherein the first pesticide is selected from the group consisting of epoxiconazole, pyraclostrobin, or metconazole.

30. The method of claim 22, wherein the second pesticide is selected from the group consisting of boscalid, chlorothalonil, or fluxapyroxad.

31. The method of claim 22, further comprising a thickener.

32. The method of claim 22, wherein the average particle size D₉₀ of the second pesticide is less than 50 μm.
